(19) United States
(12) Patent Application Publication
(10) Pub. No.: US 2019/0049565 A1
(43) Pub. Date: Feb. 14, 2019

(54) System and Method for Depth Sensing

(71) Applicant: ORYX VISION LTD., Petah Tikva (IL)

(72) Inventor: David BEN-BASSAT, Ganey Tikva (IL)

(21) Appl. No.: 16/086,784

(22) PCT Filed: Mar. 23, 2017
(86) PCT No.: PCT/IL2017/050362

§ 371 Date: Sep. 20, 2018

Related U.S. Application Data
(60) Provisional application No. 62/318,768, filed on Apr. 6, 2016.

(51) Int. Cl. G01S 7/491; G01S 17/32; G01S 17/89; G01S 17/93; G01S 7/481; H01S 3/105; H01S 3/223

(52) U.S. Cl. CPC G01S 7/4917; G01S 17/325; G01S 17/89; H01S 3/2232; G01S 7/4814; H01S 3/105; G01S 17/936

(57) ABSTRACT

A system for time of flight measurements and a method of using same are provided. The system includes an electromagnetic power source for outputting a coherent focused beam having frequency modulation. The system further includes an optical assembly including an optical transmitting element adapted to split the coherent focused beam into a signal beam and a reference beam and an optical receiver adapted to combine the reference beam with a beam reflected from an object irradiated by the signal beam, into a combined optical beam. The system further includes an antenna for converting the combined beam into an electrical current and a processor for deriving time of flight information from the electrical current.

### FIELD OF THE INVENTION

The present invention relates to a system for sensing depth of field and more particularly, to a time of flight (ToF) system for determining distance and speed of objects present around a vehicle.

### BACKGROUND OF THE INVENTION

Digital depth sensing cameras are well known in the art and are used for various applications gaming (e.g. Microsoft Kinect™), robotic navigation, 3D imaging, mapping and the like.

Depth sensing cameras are also utilized along with additional sensors (for example radars, 2D cameras and ultrasonic sensors) in ‘sensor fusion’ solutions such as the Advanced Driver Assistance System (ADAS) which provides a driver with real time data regarding the environment (scene) surrounding a vehicle (FIG. 1).

While depth sensing cameras are fundamental to sensor fusion solutions, automotive requirements pose several challenges to presently used depth sensing technologies.

Advanced Driver Assistance Systems utilize depth sensing technologies that are based on Light RADAR (LIDAR) or Time of Flight (ToF) approaches.

LIDAR is a scanning radar system that utilizes an infra red (IR) illumination source operating in a pulse mode and a sensing element for detecting the pulse reflected from an object. By measuring the time difference between transmitted pulse and received pulse, a distance may be calculated. In most cases, a single IR source (typically a laser) scans the scene one pulse at a time. A highly sensitive photo-diode optically aligned with the IR source ‘collects’ the reflected signals (one at a time) to generate a voxel ‘image’.

A Time of Flight (ToF) system typically includes an optical illuminator, illuminating the scene with modulated infra-red (IR) signals, and a sensor array for collecting the light reflected from the scene. Unlike LIDAR, the reflected light of ToF systems is simultaneously captured by an array of sensors with each sensor covering a unique sector of the scene.

In order to provide a driver with reliable depth of field information, driver assist systems must cover a field of view of 360°×20° at 150-300 meters under conditions such as direct sun light, night, rain, fog, snow and dust. In addition, the quality of the acquired depth image should enable machine recognition and segmentation of key objects in the image (e.g. human beings, cars, traffic signs, pavements etc).

Both LIDAR and ToF systems used by ADAS operate at Short Wave Infra-Red (SWIR) or near Infra-Red (NIR) frequencies which pose some limitations for ADAS.

SWIR and NIR imaging is affected by sunlight as well as visibility altering conditions such as dust, snow, rain and fog. Under such conditions, SWIR and NIR systems are limited by a shorter range and/or less than optimal depth approximation.

SWIR NIR systems include expensive components (in particularly the sensors) and require complex and accurate mechanical scanning elements as well as high power pulsed laser sources. In addition, use of a 905-1500 nm beam poses severe eye safety limitations, which dictate maximum allowed radiated power by the illuminator.

Thus, there remains a need for low cost system which can be integrated into ADAS to provide reliable depth of field information under all environmental and vehicle conditions.

### SUMMARY OF THE INVENTION

According to one aspect of the present invention there is provided a system for time of flight measurements comprising: (a) an electromagnetic power source operative to output a coherent focused beam having linear frequency modulation; (b) an optical assembly including an optical transmitting element operative to split the coherent focused beam into a signal beam and a reference beam and to forward the signal beam towards an object, and an optical receiver operative to combine the reference beam with a reflected beam, where the reflected beam is a beam returned from the object as a result of the signal beam hitting the object, into a combined optical beam; (c) an antenna operative to convert the combined beam into an electrical current; and (d) a processor operative to derive time of flight information from the electrical current.

According to further features in preferred embodiments of the invention described below, the coherent focused beam source includes a gas discharge chamber with a movable optical reflector.

According to still further features in the described preferred embodiments the movable optical reflector is movable via a piezo element.

According to still further features in the described preferred embodiments the movable optical reflector is capable of a linear displacement of 0.5-5 μm per microsecond.

According to still further features in the described preferred embodiments the linear frequency modulation of the coherent focused beam is within a range of 1-10,000 parts per million (PPM) of a carrier frequency.

According to still further features in the described preferred embodiments the coherent focused beam is generated by a sweep of ±10-100 ppm of a carrier wave every 10-1000 microseconds.

According to still further features in the described preferred embodiments the optical transmitting element is configured operate such that the power of the signal beam being forwarded towards the object is 10-100 times higher than the reference beam.

According to still further features in the described preferred embodiments the antenna is coupled to at least one metal-insulator-metal (MIM) tunnel junction.

According to still further features in the described preferred embodiments the at least one MIM tunnel junction is a frequency multiplier or a frequency mixer.

According to still further features in the described preferred embodiments the electrical current is an alternating electrical current.

According to still further features in the described preferred embodiments the frequency multiplied signal provided by the MIM element is converted to a voltage domain (F2V, via for example FFT) such that a distance is proportional to voltage.

According to still further features in the described preferred embodiments the processor derives time of flight information from the electrical current based on a time difference that exists between the reference beam and the reflected beam.

According to still further features in the described preferred embodiments the coherent focused beam source is a CO or CO2 laser.

According to still further features in the described preferred embodiments the coherent optical beam has a power of 10 Watts.

According to still further features in the described preferred embodiments the optical transmitting element and the optical receiver are optically aligned to cover a single field of view.

According to another aspect of the present invention there is provided a vehicle comprising the system described herein.

According to still further features in the described preferred embodiments the system is configured to provide a collision warning indication.

According to another aspect of the present invention there is provided a method of measuring a distance and/or speed of an object comprising: (a) splitting a coherent focused beam having a linear frequency modulation into a signal beam and a reference beam; (b) combining the reference beam with a beam reflected from the object irradiated by the signal beam into a combined optical beam; (c) converting the combined beam into an electrical current; and (d) deriving time of flight information from the electrical current.

The present invention addresses the shortcomings of the presently known configurations by providing a ToF system which can be integrated into a vehicle advanced driver assist system, in order to provide an object detection and classification under all environmental conditions.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a prior art image illustrating an Advanced Driver Assistance System (ADAS) utilizing a sensor fusion technology.

FIG. 2 is a schematic illustration of a laser having a movable reflector.

FIG. 3 is a graph illustrating a sawtooth-like displacement of a laser reflector (bottom graph) which produces a linear FM signal sweeping up and down in frequency (top graph).

FIG. 4 schematically illustrates the optical assembly construed according to an embodiment of the system of the present invention.

FIG. 5 schematically illustrates an embodiment of the system construed in accordance with an embodiment of the present invention.

FIG. 6 is an example of a graph output of the frequency multiplier function provided by a MIM element coupled to the antenna.

FIG. 7 exemplifies a typical read out circuit for a single detector of the system according to an embodiment of the present invention.

FIG. 8 exemplifies a readout circuit for a detector array of the system according to an embodiment of the present invention.

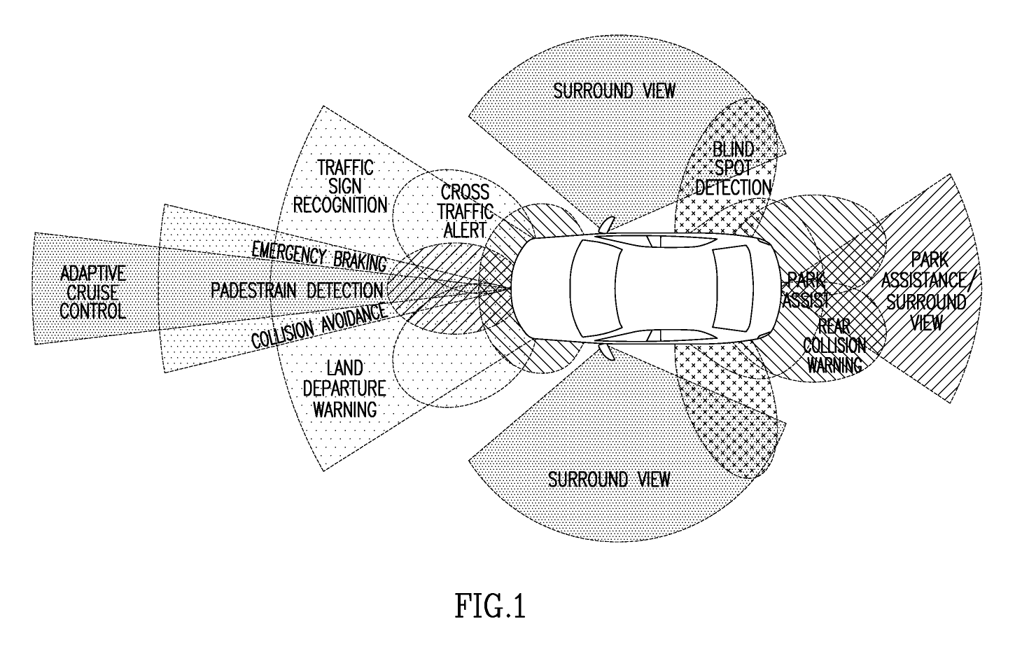

### DESCRIPTION OF THE PREFERRED EMBODIMENTS

The present invention is of a system for depth sensing. Specifically, the present invention can be used to image a scene around a vehicle and detect objects in the path of the vehicle.

The principles and operation of the present invention may be better understood with reference to the drawings and accompanying descriptions.

Before explaining any embodiments of the invention in detail, it is to be understood that the invention is not limited in its application to the details of construction and the arrangement of the components set forth in the following description or illustrated in the drawings. The scope of the invention encompasses other embodiments or embodiments being practiced or carried out in various ways. Also, it is to be understood that the phraseology and terminology employed herein is for the purpose of description and should not be regarded as limiting.

Time-of-Flight (ToF) cameras produce a depth image in which each pixel encodes a distance to a corresponding point in a scene (target) by measuring the phase-delay of reflected infrared (IR) light. Although IR ToF cameras are suitable for depth sensing under controlled environmental conditions, their depth of field and resolution are inadequate for ADAS under full sunlight or sub optimal visual conditions.

While reducing the present invention to practice, the present inventor has devised a system which utilizes ToF technology to map and identify objects also in a scene under full sunlight and sub optimal visual conditions while being eye safe for use.

The system transmits a focused coherent IR beam for illuminating a scene and the reflected signal is cross-correlated with the transmitted signal to yield an optimal matched-filter receiver. The coherent system allows a substantially improved link budget since the receiving channel is optimally matched with the transmitting channel, which in turn translates to significantly enhanced performance versus existing solutions.

Thus, according to one aspect of the present invention there is provided a system for time of flight measurements.

The system includes an electromagnetic power source (e.g. a laser) for outputting a coherent focused beam having linear frequency modulation. As is further described hereinunder, a focused beam having linear frequency modulation (the beam is also referred to herein as being “continuous wave frequency modulated”) can be generated, for example, by altering (over time) a distance between two reflectors of a gas discharge chamber of a laser. The coherent focused beam can be an IR laser beam with a wavelength oscillating between 900 and 10,000 nm. Examples of laser units suitable for use with the present system include, but are not limited to CO₂ laser, CO laser, Quantum cascade laser (QCL), Vertical-cavity surface-emitting laser (VCSEL).

The system further includes an optical assembly which includes an optical transmitting element for splitting the coherent focused beam into a signal beam (for illuminating a scene) and a reference beam (which is directed to an optical receiver). As is further described hereinunder, such splitting can be at a power ratio of 1000-1 to 1-10 (signal/reference).

The system further includes an optical receiver for combining the reference beam with a beam reflected from an object irradiated by the signal beam.

The optical assembly can be constructed from an optical channel devised to focus the energy from the scene to an imager array.

The system further includes an antenna (e.g. nanoantenna) for converting the combined beam into an electrical signal (e.g. alternating current, or alternating voltage). Such an antenna can be coupled to at least one metal-insulator-metal (MIM) tunnel junction (also referred to as MIM diode) which serves as a non-linear frequency multiplier. The MIM functions as an efficient high frequency rectifier by allowing quantum tunneling of charges from high to low potential. The electrical currents of the two signals (reflected signal+reference signal) are mixed by the MIM element to provide zero IF down conversion of the modulated signal. Thus, the tunnel junction of the MIM element acts as a frequency-mixer when interrogated simultaneously by two harmonic signals (chirp and time delayed chirp). Since the reference signal is of the same source as the reflected signal, frequency mixing provides a down-converting function—converting frequency directly to the base band, hence zero IF.

An electrical filter can be applied to the converted signal to reject signals in the electrical base band regime. Such a filter is very well defined and very sharp, approximating an optimal matched filter function which optimizes signal to noise.

As is further described hereinbelow, the MIM element multiplies the two signals (chirp multiplied by a time delayed chirp); the resulting frequency (FIG. 6) is linearly proportional to the time delay and as such enables determination of the time delay by transforming the resulting signal via for Example, fast Fourier transform (FFT).

A plurality of antenna-MIM units can be incorporated into an array for collecting information from a scene illuminated by a single coherent focused beam coupled to a single optical assembly. Such information can be used to derive ToF from numerous discrete or overlapping regions of a scene to enable identification of objects (stationary or moving) present in the scene (i.e. to isolated objects from the background) and derive a relative velocity thereof. Information from such an array can also be used to map the 3D shape of objects, and derive relative angular velocities.

In order to identify objects, the present system employs a processing unit (e.g. comprising one or more processors) which can be dedicated to an antenna-MIM unit or an entire array thereof. The processing unit processes the electrical current generated by the antenna-MIM element to extract ToF information by calculating a time difference between the reference beam and the beam reflected from the object irradiated by the signal beam.

The present invention provides several advantages over presently known ToF systems:

(i) due to its improved link budget, the present system can utilize a coherent focused beam having power of 10 Watts or less;

(ii) it is not affected by direct sunlight or conditions of poor visibility (rain, snow, fog, dust etc) since the 10 μm wavelength collected by the optical assembly is less affected by poor visibility conditions and is virtually non-existent in sunlight; and

(iii) it utilizes coherent detection which provides a more accurate depth estimation, an improved link budget, a much more power-efficient system, and much higher data generation rate.

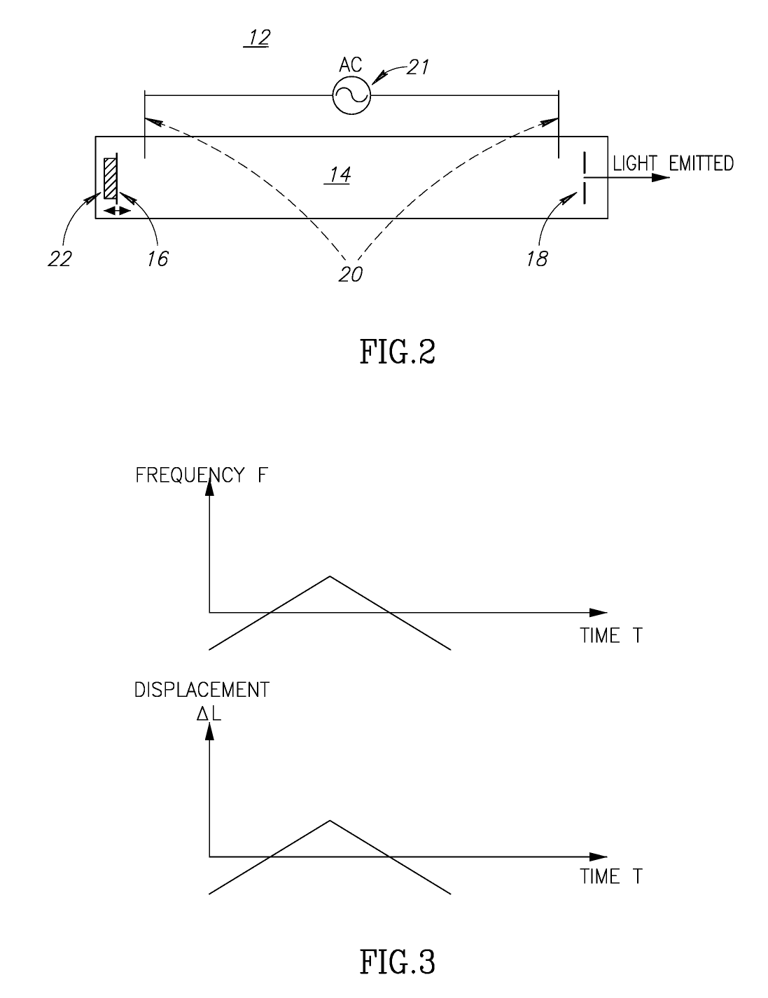

Embodiments of the present system, which is referred to hereinunder as system 10, are described in greater detail with reference to FIGS. 2-5.

FIG. 2 illustrates electromagnetic power source 12 (also referred to herein as source 12) for outputting a coherent focused beam (e.g. laser beam). Source 12 can be a gas laser such as a CO or CO₂ laser capable of outputting a coherent focused beam of 10 Watts. Other coherent focused beam sources that can be used by the present system include, but are not limited to, QCL, VCSEL, DFB lasers and the like.

Source 12 includes a chamber 14 containing a specific mixture of gases. Two reflectors (e.g. mirrors) 16, 18 are placed at the two ends of the chamber and electrodes 20 are placed within the chamber. The gas is excited by electrical current 21 provided through electrodes 20 (either DC or RF excitation). Upon excitation, the gas undergoes a spontaneous emission of photons. Reflectors 16 and 18 are spaced an integer number of wavelengths apart and lasing occurs as the photons excite further emission from the gas. The space extending between reflectors 16 and 18 is referred to as a resonator, and to maintain lasing the following relationship is required from the resonator:

L=nλ (1)

### Where:

L is the distance between reflectors 16 and 18
n is an integer number
λ is the wavelength of the laser

Optical filters can be placed within the chamber, or on reflector(s) 16, 18 in order to prevent certain modes of lasing and allow only specific lasing modes to oscillate within the chamber. Reflector 18 is partially transmissive thus allowing selected lasing energy to escape the chamber in the form of a coherent focused beam.

In order to output a coherent focused beam having linear frequency modulation, the laser chamber described above is modified such that reflector 16 and/or 18 is positioned on a linear displacement mechanism 22. Mechanism 22 can include a piezo element or a step motor attached to reflector 16 and/or 18. The piezo element or motor can displace reflector 16 and/or 18 a distance equal to one or more wavelengths per unit time. Such displacement can be 0.5-5 microns per microsecond resulting in linear frequency modulation of the coherent focused beam within a range of 1-10000 parts per million (PPM) or 0.000001%-0.01% of a carrier frequency. The frequency range of the coherent focused beam is generated by a sweep of reflector 16 or 18 of +/−10-10000 ppm of the carrier wave frequency every 10-10,000 microseconds. According to one embodiment of the present invention, the wavelength of the coherent focused beam outputted by source 12 oscillates between 900-10,000 nm and as such, mechanism 22 displaces reflector 16 and/or 18 1 μm/μSec.

Thus, by slightly changing the resonator total length (marked L in Equation 1), the laser wavelength (marked λ in Equation 1) will change, as shown in equation 2:

$$λ + Δ λ = \frac{L + Δ L}{n} == > Δ λ = \frac{Δ L}{n}$$

In accordance with Equation 2, changing the resonator length by ΔL yields a wavelength shift of the laser by Δλn. Using a piezo element, the wavelength of the laser can be actively changed over time as described herein:

Assuming the displacement versus time is described as ΔL(t), the change in wavelength versus time is described as ΔL(t)/n. Thus, implementing a linear displacement of ΔL(t)=at, where a is a constant can produce a linear FM signal. By implementing, for example, a sawtooth displacement function one can obtain the linear FM signal sweeping up and down in frequency shown in FIG. 3. The sawtooth pattern generates a rising and falling (undulating) CHIRP which enables estimation of velocity (as well as distance) of objects in a scene.

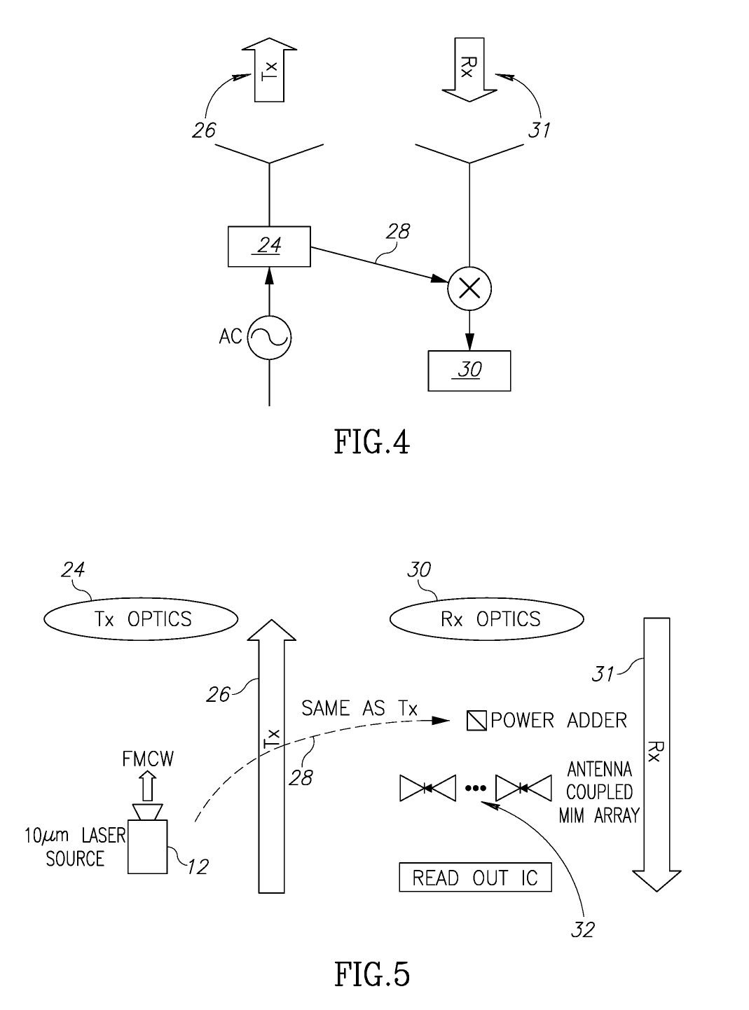

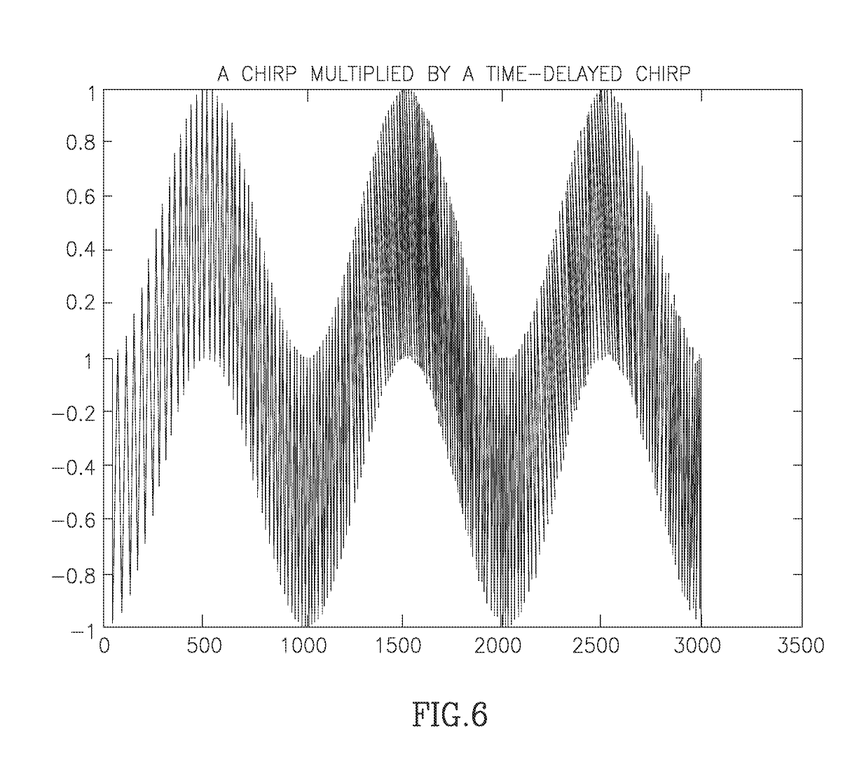

Once the coherent focused beam is generated and outputted by source 12, it is split via an optical transmitting element 24 (optical splitter) to two optical channels (FIGS. 4-5).

Optical transmitting element 24 can be an optical lens which includes one or more elements used to dissipate the radiated light in accordance with the required field of view (FOV). For example, if the required field of view is 90° HX20° V, the lens will be such that dissipates the coherent focused beam to such a sector which is 90° HX20° V.

Receiver 30 is closely positioned to and optically aligned with optical transmitting element 24 such that it covers the same sector or FOV as optical transmitting element 24.

In order to enable such an alignment, receiver 30 and element 24 are co-packaged in a single housing which is configured for such purposes.

Receiver 30 can be an optical lens having one or more elements for collecting the light reflected from the scene (indicated by 31). The lens can have similar optical properties as the lens in transmitting element 24.

One or more (e.g. array) of detectors 32 (FIG. 5) are positioned at the focal point of receiver 30. Detectors 32 are arranged to allow generation of a depth image in an array of X by Y pixels (e.g. 50-1000 by 50-1000).

Each detector 32 of a detector array is illuminated by two signals simultaneously, signal beam 26 reflected from the scene and received at receiver 30 and reference beam 28 transmitted directly to receiver 30.

Equation 3 below describes the transmitted signal, assuming Continuous Wave Frequency Modulation (CWFM) is implemented at source 12 as described above:

S_{T}(t)=A sin [2π(f_{c}+at)t]

### Where:

A is the signal amplitude
Fc is the center frequency of the laser [Hz]
A is the modulation rate [Hz/Sec]
T is time

Accordingly, Equation 4 is the signal reaching each detector 30:

S_{R}(t+Δt)=B sin {2π[f_{c}+a(t+Δt)][t+Δt]}+C sin {2π[f_{c}+at]t}

### Where:

B is the coupled transmitter signal amplitude
Δt is the time difference between transmitter signal and received signal. It is proportional to the distance, as the distance is given by multiplying the time difference with the speed of light.
C is the received signal power

Each detector 30 includes an antenna coupled to one or more MIM elements. The latter is a high speed non-linear element capable of converting antenna-absorbed beams 26 and 28 into electrical AC currents and multiplying the two harmonic current signals (of beams 26 and 28) to obtain a frequency-mixed signal (FIG. 6).

Equation 5 describes the signal generated by the MIM element:

I_{R}(t+Δt)≈B sin {2π[f_{c}+a(t+Δt)][t+Δt]}*C sin {2π[f_{c}+at]t}

### Where:

I is the current generated across the MIM.

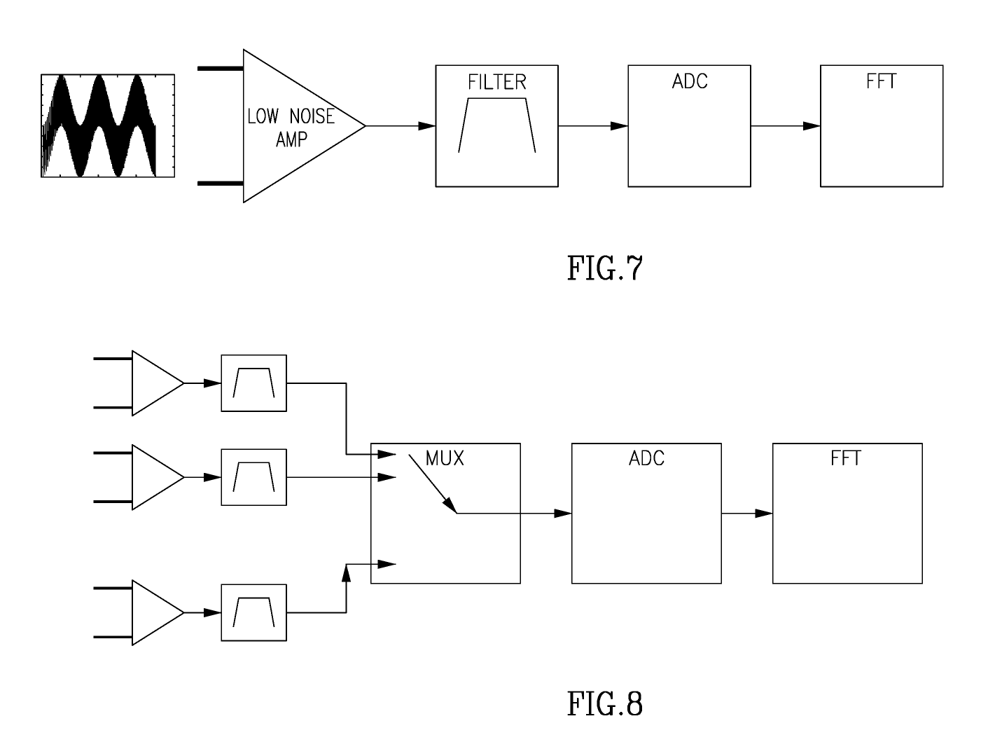

The output of detector 30 is a frequency that includes distance information (per detector or ‘pixel’). This output is fed into a read out circuit that generates a voltage which is proportional to the distance. FIG. 7 illustrates a typical read out circuit per pixel (detector 30). The single sensor output (a chirp multiplied by a time delayed chirp) is passed through a low noise amplifier in order to amplify the received signal to a level where it can be further processed (both analog and digital processing) without affecting signal to noise, filtered via electrical circuits that serve as filters, converted from analog to digital (ADC) and transformed (FFT) to derive the voltage domain of the signal. A circuit for multiplexing several pixels (signals from several detectors 30) with a single ADC is shown in FIG. 8.

The voltage reading from one or more detectors 30 can then processed by a microprocessor (e.g. a GPU such as the Nvidia Tegra II) to derive distance/velocity information.

System 10 of the present invention can provide depth of field information such as distance to objects, relative velocity of objects, shape of objects as well as any information typically obtainable from ToF systems.

System 10 is particularly suitable for use in vehicle driver assist systems (e.g. ADAS).

System 10 can be packaged and mounted at one or several points around the vehicle and connected to the car battery for power and car driver assist system for processing, display and integration with additional assist systems.

As used herein the term “about” refers to ±10%.

Additional objects, advantages, and novel features of the present invention will become apparent to one ordinarily skilled in the art upon examination of the following example, which is not intended to be limiting.

### EXAMPLE

Reference is now made to the following example, which together with the above descriptions, illustrate the invention in a non-limiting fashion.

### Exemplary System

System 10 of the present invention can be constructed with the following components and parameters:

FoV

| | |
|---|---|
| H | 90° |
| V | 20° |

Sensor resolution

| | | |
|---|---|---|
| X | 450 | pixels |
| Y | 30 | pixels |

| | |
|---|---|
| total | 13500 |

Target

| | | |
|---|---|---|
| range | 160 | m |

pixel size

| x | 0.56 | m |
|---|---|---|
| y | 1.86 | m |
| area | 1.04 | m2 |
| reflectivity | 80% | |
| background emission | 30 | W/m²/um |

Transmitting Lens (Tx)

| | | |
|---|---|---|
| power | 5 | W |
| power/pixel | 370.370370 | uW/pixel |

Symbol (Chirp)

| | | |
|---|---|---|
| length | 1.00E−03 | Sec |
| bandwidth (BW) | 1.00E+03 | Hz |

Receiving lens (Rx)

| diameter | 0.02 | m |
|---|---|---|
| area | 0.000314159 | m² |
| Link losses | 512000000 | |
| Front end filter | 1.00E−06 | m |

Detector (MIM coupled antenna)

| | | |
|---|---|---|
| Signal | 1.14E−08 | A_{RMS} |

Noise

| | | |
|---|---|---|
| Photonic shot noise | 1.34E−10 | A_{RMS} |
| electrical shot noise | 4.00E−10 | A_{RMS} |
| thermal noise | 1.82E−10 | A_{RMS} |
| total | 4.593E−10 | A_{RMS} |

| | |
|---|---|
| SNR | 2.48E+01 |

| | |
|---|---|
| 2.79E+01 | dB |

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for time of flight measurements comprising:
(a) an electromagnetic power source operative to output a coherent focused beam having frequency modulation;
(b) an optical assembly including:
(b.1) an optical transmitting element operative to split said coherent focused beam into a signal beam and a reference beam, and to forward the signal beam towards an object; and
(b.2) an optical receiver operative to combine said reference beam with a reflected beam, where said reflected beam is a beam returned from the object as a result of the signal beam hitting said object, into a combined optical beam;
(c) an antenna operative to convert said combined beam into an electrical signal; and
(d) a processor operative to derive time of flight information from said electrical signal.

2. The system of claim 1, wherein said coherent focused beam source includes a gas discharge chamber with a movable optical reflector.

3. The system of claim 2, wherein said movable optical reflector is movable via a piezo element.

4. The system of claim 1, wherein said movable optical reflector is capable of a linear displacement.

5. The system of claim 1, wherein said linear frequency modulation of said coherent focused beam is within a range of 1-10,000 parts per million (PPM) of a carrier frequency.

6. The system of claim 1, wherein said coherent focused beam includes is generated by a sweep of ±10-10,000 ppm of a carrier wave every 10-10,000 microseconds.

7. The system of claim 1, wherein said antenna is coupled to at least one metal-insulator-metal (MIM) tunnel junction.

8. The system of claim 7, wherein said at least one MIM tunnel junction is a frequency multiplier or a frequency mixer.

9. The system of claim 1, wherein said electrical signal is an alternating electrical signal.

10. The system of claim 1, wherein said processor derives time of flight information from said electrical current based on a time difference between said reference beam and said reflected beam.

11. The system of claim 1, wherein said coherent focused beam source is a CO or CO2 laser.

12. The system of claim 1, wherein said coherent optical beam has a power of 10 Watts.

13. The system of claim 1, wherein said optical transmitting element and said optical receiver are optically aligned to cover a single field of view.

14. A vehicle comprising the system of claim 1.

15. The vehicle of claim 14, wherein said system is configured to provide a collision warning indication.

16. A method of measuring a distance and/or speed of an object comprising:
(a) splitting a coherent focused beam having a linear frequency modulation into a signal beam and a reference beam
(b) combining said reference beam with a beam reflected from the object irradiated by said signal beam into a combined optical beam;
(c) converting said combined beam into an electrical current; and
(d) deriving time of flight information from said electrical current.
